(19) United States
(12) Patent Application Publication
(10) Pub. No.: US 2026/0132683 A1
(43) Pub. Date: May 14, 2026

(54) SYSTEM AND METHOD FOR EXTERNAL POWER GENERATION FOR MOBILE RIGS FOR WELLS

(71) Applicant: Service King Manufacturing, Inc., Stroud, OK (US)

(72) Inventors: Robert Gordon, Stroud, OK (US); Bobby Fisk, Stroud, OK (US); Bryan Grisham, Stroud, OK (US); Bobby Stinson, Stroud, OK (US); Josh Raper, Stroud, OK (US); Marty Bukowski, Stroud, OK (US)

(21) Appl. No.: 19/387,101

(22) Filed: Nov. 12, 2025

Related U.S. Application Data
(60) Provisional application No. 63/719,421, filed on Nov. 12, 2024.

(51) Int. Cl. E21B 7/02; F02B 63/04

(52) U.S. Cl. CPC E21B 7/026; E21B 7/022; F02B 63/047

(57) ABSTRACT

An external power generation system for a mobile well rig, comprising a chassis supporting: a variable-frequency drive configured to control an electric motor configured to receive electrical energy from the variable-frequency drive and convert the electrical energy into mechanical energy; a transmission; a drive shaft mechanically connecting the electric motor and the transmission; and a drive system comprising a first gear box, an input shaft mechanically connecting the transmission and the first gear box, and an output shaft having a proximal end rotatably engaged with the first gear box and a distal end extending beyond the chassis and connectable to a rig output shaft of a mobile well-rig, thereby transferring mechanical energy to the rig output shaft and from the rig output shaft to a drawworks of the well-rig to raise and lower equipment suspended from a mast of the well-rig.

### CROSS-REFERENCE TO RELATED APPLICATIONS

This application claims the benefit under 35 USC § 119(e) to the Provisional Patent Application identified by U.S. Ser. No. 63/719,421, filed Nov. 12, 2024, the entire contents of which are hereby incorporated by reference herein.

### FIELD OF THE DISCLOSURE

The disclosure generally relates to systems and methods for providing alternate power to mobile rigs used in well drilling and well workover, which may be referred to herein as mobile well-rigs or simply rigs. The well-rigs may be used for drilling and/or servicing wells for natural gas, oil, water, or other types of wells. More particularly the disclosure relates to an external, electric, power generation system for use in conjunction with mobile well-rigs in order to take the place of energy provided by diesel engines or gasoline engines on the mobile well-rigs.

### BACKGROUND

Currently, many mobile well-rigs use a diesel engine or a gasoline engine to provide mechanical energy to run subsystems of the mobile well-rigs. For example, a diesel engine may be used to power the drawworks of a rig, which is used to raise or lower equipment on the mast of the rig. However, these types of engines run on petroleum products and output emissions such as carbon dioxide.

Current governmental regulations and programs, such as the U.S. Environmental Protection Agency Greenhouse Gass Reporting Program, require that owners or operators of onshore petroleum and natural gas production wells and related equipment report the combined greenhouse gas emissions for all wells that they own or operate within each hydrocarbon basin to the U.S. Environmental Protection Agency. Emissions from stationary and portable fuel combustion equipment must be included. However, greenhouse gas emissions can be difficult, time consuming, and expensive, to track and report.

Additionally, petroleum-run engines produce noise at levels higher than allowed by some governmental entities, which is problematic when rigs are located near populated areas.

An alternative to mobile well-rigs that use petroleum-run engines are rigs that are run with electricity, which eliminates the engine as a source of greenhouse gas emissions and greatly reduces noise levels compared to petroleum-run engines. However, well-rigs having engines that run on petroleum-based fuel are numerous and would be expensive to replace or completely retrofit to replace the engines on the rigs.

Therefore, systems and methods are needed that can provide electrical-based power to the mobile well-rigs to reduce or replace the use of emission-producing, noisy, engines, without having to replace or extensively retrofit the current rigs.

### SUMMARY

Mobile alternate-power systems for external, electrical-based, power generation for mobile well-rigs, and methods of use of those systems, are disclosed. The problems of reducing or eliminating greenhouse gas emissions from emission-producing engines, and therefore, the need to track those emissions, as well as reducing noise levels from rigs, is addressed through the use of a mobile, electrical-based, power-generation system in conjunction with a well-rig.

In some embodiments, an external power generation system for a mobile well rig, comprises: a power-generation-system (PGS) chassis; a motor controller mounted on the PGS chassis, the motor controller having an electrical power interface configured to receive electrical energy from an external electric energy source and output the electrical energy; an electric motor mounted on the PGS chassis and configured to receive the electrical energy from the motor controller and convert the electrical energy into mechanical energy; a transmission mounted on the PGS chassis; a drive shaft having a proximal end rotatably engaged with the electric motor and having a distal end rotatably engaged with the transmission, the drive shaft configured to transfer the mechanical energy from the electric motor to the transmission; and a drive system mounted on the PGS chassis, the drive system comprising: a first gear box having one or more PGS gears; an input shaft having a proximal end rotatably engaged with the transmission and a distal end rotatably connected to the first gear box, the input shaft configured to transfer the mechanical energy from the transmission to the first gear box; and an output shaft having a proximal end rotatably engaged with the first gear box and a distal end extending beyond the chassis and configured to be rotatably connected to a rig output shaft of a mobile well-rig, thereby transferring the mechanical energy to the rig output shaft, the rig output shaft configured to transfer the mechanical energy to a drawworks of the mobile well-rig to raise and lower equipment suspended from a mast of the mobile well-rig. The motor controller may be a variable-frequency drive.

In some embodiments, a mobile well-rig alternate power system comprises: a mobile well-rig, comprising: a rig chassis; an engine supported by the rig chassis, the engine configured to run on petroleum products to produce mechanical energy; a mast movably mounted on the rig chassis such that the mast is movable between a transport position and an operating position; a drawworks mounted on the rig chassis and configured to raise and lower equipment suspended from the mast when the mast is in the operating position; and a rig drive system mounted on the rig chassis, the rig drive system comprising: a rig gear box having one or more rig gears; a rig input shaft having a proximal end driven by the engine and a distal end rotatably engageable with the one or more rig gears in the rig gear box, the rig input shaft configured to transfer mechanical energy from the engine to the rig gear box when the rig input shaft is engaged with the rig gear box; and a rig output shaft having a proximal end and a distal end, the distal end mechanically rotatably engaged with the drawworks, the rig output shaft configured to transfer mechanical energy to the drawworks to raise and lower the equipment suspended from the mast, the rig output shaft having a first state in which the rig output shaft receives mechanical energy via the rig gears from the rig input shaft and having a second state in which the rig output shaft receives no mechanical energy from the rig input shaft when the rig input shaft is disengaged from the rig gears of the rig gear box.

In some embodiments, the mobile well-rig alternate power system comprises a mobile power generation system (PGS), positioned external to the mobile well-rig, comprising: a PGS chassis; a motor controller mounted on the PGS chassis, the motor controller having an electrical power interface configured to receive electrical energy from an external electrical energy source and output the electrical energy; an electric motor mounted on the PGS chassis and configured to receive the electric energy from the motor controller and convert the electrical energy into mechanical energy; a transmission mounted on the PGS chassis; a drive shaft having a proximal end rotatably engaged with the electric motor and having a distal end rotatably engaged with the transmission, the drive shaft configured to transfer the mechanical energy from the electric motor to the transmission; and a PGS drive system mounted on the PGS chassis, the PGS drive system comprising: a PGS gear box having one or more PGS gears; a PGS input shaft having a proximal end rotatably engaged with the transmission and a distal end rotatably engaged with the PGS gears of the PGS gear box, the PGS input shaft configured to transfer the mechanical energy from the transmission to the PGS gears of the PGS gear box; and a PGS output shaft having a proximal end rotatably engaged with the PGS gears of the PGS gear box and a distal end extending beyond the PGS chassis and rotatably engageable with the rig output shaft of the mobile well-rig when the rig output shaft is in the second state, such that when the rig input shaft is disengaged from the rig gears of the rig gear box and the PGS output shaft is engaged with the rig gear box, the PGS output shaft is configured to transfer the mechanical energy through the rig output shaft to the drawworks of the mobile well-rig.

In some embodiments, a method for providing alternate power to a mobile well-rig comprises positioning a mobile power generation system (PGS) proximate to a mobile well-rig, the mobile well-rig comprising: a rig chassis; an engine supported by the rig chassis, the engine configured to run on petroleum products to produce mechanical energy; a mast movably mounted on the rig chassis such that the mast is movable between a transport position and an operating position; a drawworks mounted on the rig chassis and configured to raise and lower equipment suspended from the mast when the mast is in the operating position; and a rig drive system mounted on the rig chassis, the rig drive system comprising: a rig gear box having one or more rig gears; a rig input shaft having a proximal end driven by the engine and a distal end rotatably engageable with the rig gear box, the rig input shaft configured to transfer mechanical energy from the engine to the rig gear box when the rig input shaft is engaged with the rig gear box; and a rig output shaft having a proximal end and a distal end, the distal end mechanically rotatably engaged with the drawworks, the rig output shaft configured to transfer mechanical energy to the drawworks to raise and lower the equipment suspended from the mast, the rig output shaft having a first state in which the rig output shaft receives mechanical energy via the rig gears from the rig input shaft and having a second state in which the rig output shaft receives no mechanical energy from the rig input shaft when the rig input shaft is disengaged from the rig gears of the rig gear box.

In some embodiments, the mobile power generation system (PGS) comprises: a PGS chassis; a motor controller mounted on the PGS chassis, the motor controller having an electrical power interface configured to receive electrical energy from an external electrical energy source and output the electrical energy; an electric motor mounted on the PGS chassis and configured to receive the electric energy from the motor controller and convert the electrical energy into mechanical energy; a transmission mounted on the PGS chassis; a drive shaft having a proximal end rotatably engaged with the electric motor and having a distal end rotatably engaged with the transmission, the drive shaft configured to transfer the mechanical energy from the electric motor to the transmission; and a PGS drive system mounted on the PGS chassis, the PGS drive system comprising: a PGS gear box having one or more PGS gears; a PGS input shaft having a proximal end rotatably engaged with the transmission and a distal end rotatably engaged with the PGS gear box, the PGS input shaft configured to transfer the mechanical energy from the transmission to the PGS gear box; and a PGS output shaft having a proximal end rotatably engaged with the PGS gear box and a distal end extending beyond the PGS chassis and rotatably engageable with the rig gear box of the mobile well-rig.

In some embodiments, the method comprises disengaging the distal end of the rig input shaft from the rig gears of the rig gear box; engaging the PGS output shaft of the PGS drive system with the rig output shaft; and activating the electric motor of the mobile power generation system, thereby providing mechanical energy through the transmission and the PGS drive system to the drawworks of the mobile well-rig. The motor controller may be a variable-frequency drive.

In some embodiments, the method may comprise attaching a first end of one or more chassis-connectors to the rig chassis; and attaching a second end of the one or more chassis-connectors to the PGS chassis, such that the rig chassis and the PGS chassis are rigidly connected.

In some embodiments, positioning the mobile power generation system proximate to the mobile well-rig comprises positioning the mobile power generation system longitudinally to the mobile well-rig at a distance of less than twelve inches.

In some embodiments, the mobile power generation system comprises one or more adjustable supports connected to the PGS chassis, and the method comprises adjusting the adjustable supports to vertically position the PGS drive system such that the PGS output shaft forms an angle of between three degrees and five and a half degrees vertically from a longitudinal axis of the rig output shaft.

### BRIEF DESCRIPTION OF THE DRAWINGS

The accompanying drawings, which are incorporated in and constitute a part of this specification, illustrate one or more embodiments described herein and, together with the description, explain these embodiments. The drawings are not intended to be drawn to scale, and certain features and certain views of the figures may be shown exaggerated, to scale, or in schematic, in the interest of clarity and conciseness. Not every component may be labeled in every drawing. Like reference numerals in the figures may represent and refer to the same or similar element or function. In the drawings:

FIG. 1 is a perspective top-side view of an exemplary, mobile, well rig alternate power system in accordance with the present disclosure.

FIG. 2 is a top plan view of the exemplary, mobile, well rig alternate power system of FIG. 1.

FIG. 3 is a side plan view of the exemplary, mobile, well rig alternate power system of FIG. 1.

FIG. 4 is a front end view of the exemplary, mobile, well rig alternate power system of FIG. 1.

FIG. 5 is a top plan view of an exemplary well rig, shown without the mast, of the exemplary, mobile, well rig alternate power system of FIG. 1 in accordance of the present disclosure.

FIG. 6 is a side view of the exemplary well rig of FIG. 5.

FIG. 7 is a top plan view of exemplary components of the exemplary well rig of FIG. 5 in accordance with the present disclosure.

FIG. 7A is a schematic view of exemplary components of a rig drive system in accordance with the present disclosure.

FIG. 7B is a side perspective view of exemplary components of a rig drive system in accordance with the present disclosure.

FIG. 8 is a side plan view of the exemplary components of FIG. 7.

FIG. 8A is a perspective view of some of the exemplary components of FIG. 7.

FIG. 9 is a perspective top-side view of an exemplary, mobile, electrically based, power generation system of the exemplary, mobile, well rig alternate power system of FIG. 1 in accordance of the present disclosure.

FIG. 9A is a perspective view of an exemplary transmission cooling system of a power generation system in accordance of the present disclosure.

FIG. 10 is a side plan view of the power generation system of FIG. 9.

FIG. 11 is a side plan view of another exemplary power generation system in accordance with the present disclosure.

FIG. 12 is a top plan view of exemplary components of the exemplary well rig of FIG. 5 and the power generation system of FIG. 9 engaged with each other, in accordance with the present disclosure.

FIG. 12A is a top plan diagrammatic view of exemplary components of the power generation system of FIG. 12 in accordance with the present disclosure.

FIG. 12B is a front end diagrammatic view of exemplary components of a well rig and a power generation system in accordance with the present disclosure.

FIG. 12C is a top perspective view of exemplary components of a well rig and a power generation system in accordance with the present disclosure.

FIG. 12D is a top perspective view of exemplary components of a power generation system in accordance with the present disclosure.

FIG. 13 is a process flow diagram of an exemplary method in accordance with the present disclosure.

### DETAILED DESCRIPTION

The following detailed description refers to the accompanying drawings. The same reference numbers in different drawings may identify the same or similar elements.

The mechanisms proposed in this disclosure circumvent the problems described above. The present disclosure describes a systems and methods for providing alternate energy to a well-rig.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to manufacturing tolerances, measurement error, wear and tear, stresses exerted on various parts, operator error/variances, and combinations thereof, for example.

The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

Further, the phrase “based on” is intended to mean “based, at least in part, on” unless explicitly stated otherwise.

As used herein, any reference to “one embodiment,” “an embodiment,” “some embodiments,” “one embodiment,” “some embodiments,” “an embodiment,” “one example,” “for example,” or “an example” means that a particular element, feature, structure, or characteristic described in connection with the embodiment/embodiment/example is included in at least one embodiment/embodiment/example and may be used in conjunction with other embodiments/embodiments/examples. The appearance of the phrase “in some embodiments” or “one example” or “in some embodiments” in various places in the specification does not necessarily all refer to the same embodiment/embodiment/example, for example.

As discussed above, systems and methods are needed to reduce or eliminate greenhouse gas emissions of engines used on mobile well-rigs, and the tracking thereof, as well as to reduce or eliminate noise from engines used for mobile well-rigs. The present disclosure addresses these deficiencies with systems and methods of use for external, electrically-powered, energy generation for mobile well-rigs, without the need to replace or extensively retrofit current well-rigs.

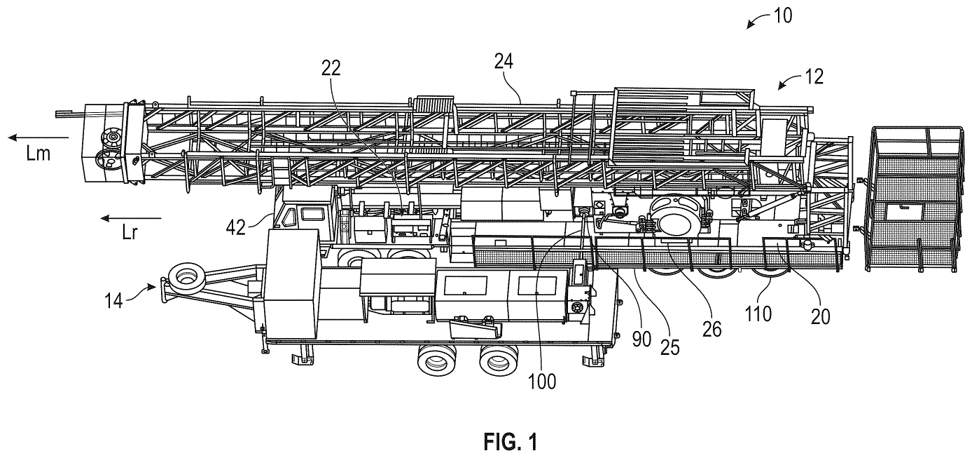

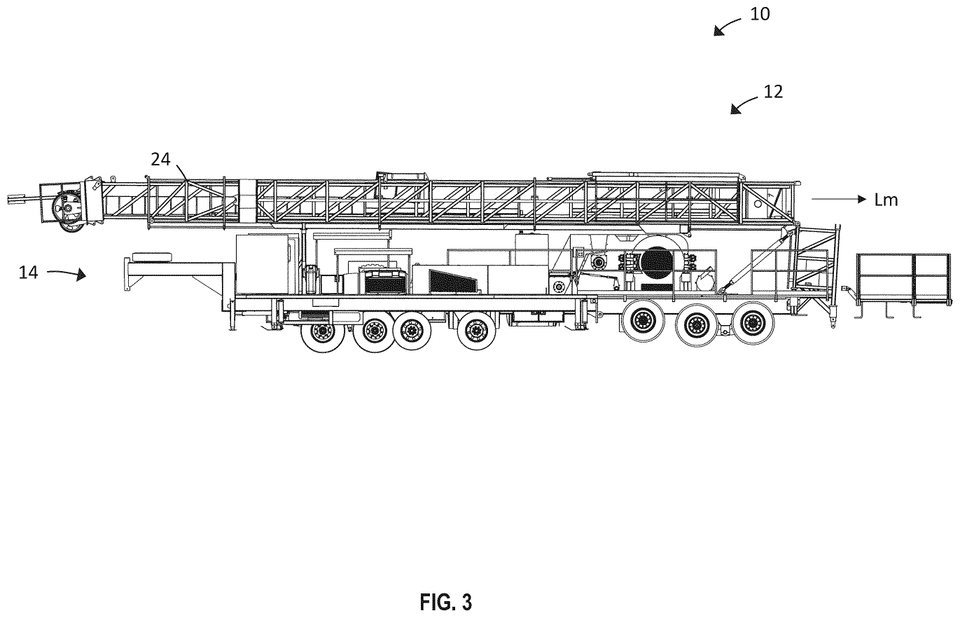

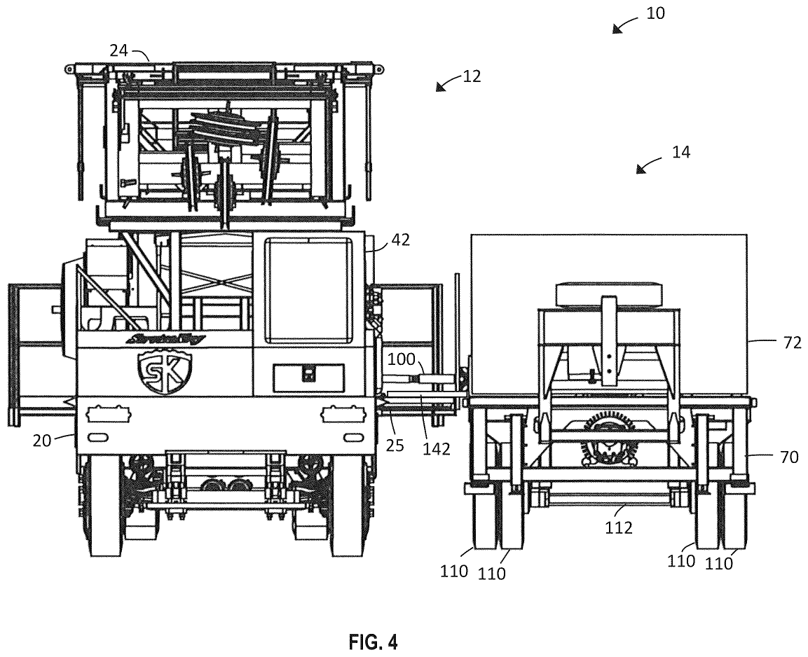

Referring now to the drawings, and in particular to FIGS. 1-4, shown therein is a mobile well-rig alternate power system 10. In general, the mobile well-rig alternate power system 10 may comprise a mobile well-rig 12 (which may be referred to as well rig 12, or simply, rig 12) and a mobile power generation system 14 (which may be referred to as PGS 14 or power generation system 14) that is engageable with the well rig 12 for use in conjunction with the well rig 12.

In some embodiments, the mobile well-rig 12 is a mobile drilling rig for drilling a well. In some embodiments, the mobile well-rig 12 is a mobile workover rig for servicing a well.

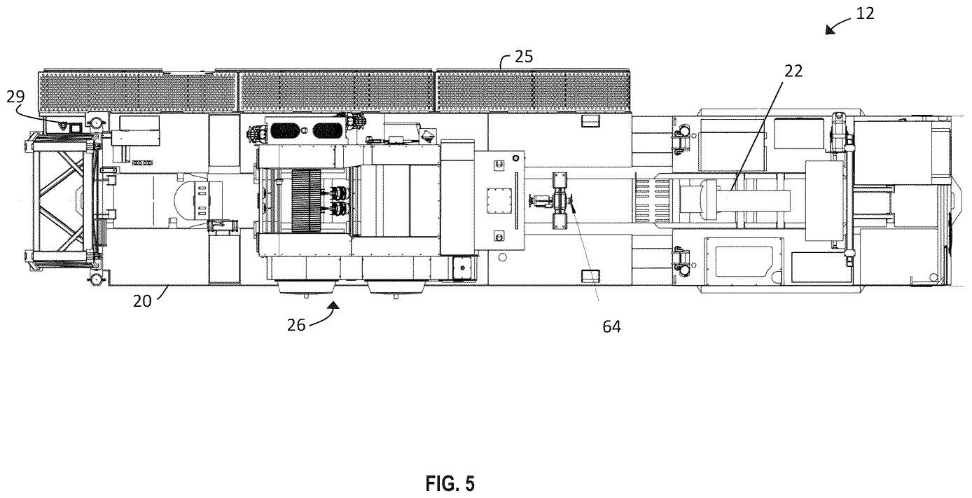

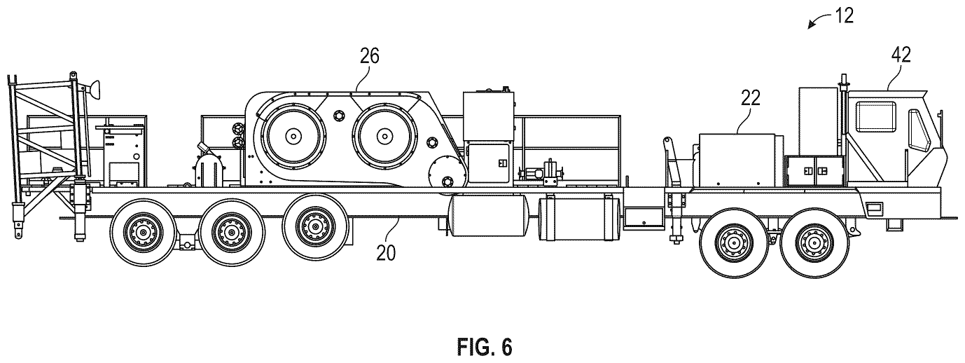

As also shown in FIGS. 5 and 6, the mobile well-rig 12 may comprise a rig chassis 20, an engine 22 supported by the rig chassis 20, a mast 24 movably mounted on the rig chassis 20, a drawworks 26 mounted on the rig chassis 20 which is configured to move equipment suspended on the mast 24, and a rig drive system 28 mounted on the rig chassis 20 which is configured to transfer mechanical energy to the drawworks 26.

In some embodiments, the mobile well-rig 12 may comprise a walkway 25 positioned along a first side of the mobile well-rig 12. The mobile well-rig 12 may comprise an elevator positioned along the first side or a second side of the mobile well-rig 12 and configured to raise and lower an operator vertically. In some embodiments, the mobile well-rig 12 may comprise a controller 29 configured to control operations of the mobile well-rig 12, such as, but not limited to, raising and lowering the mast 24, moving equipment suspended on the mast by controlling the drawworks 26, operation of the engine 22, pneumatic controls for the rig 12 and/or equipment on the rig 12, and hydraulic controls for the rig 12 and/or equipment on the rig 12. The controller 29 has one or more user interfaces configured to allow an operator to control operations of the mobile well-rig 12 through the controller 29. In some embodiments, the controller 29 is positioned near or on the elevator.

The rig chassis 20 of the well rig 12 may be part of a vehicle, such that the well rig 12 may be moved to and from well sites. The vehicle may comprise a plurality of rig wheels 40 supporting the rig chassis 20. In some embodiments, the vehicle may comprise a cab 42 having controls for driving the vehicle. As one example, the vehicle may be a truck. As one example, the vehicle may be a trailer. Other components of the vehicle are not shown or described in detail herein, as the structure of vehicles is well known to people having ordinary still in the art.

The engine 22 of the well rig 12 is configured to run on petroleum products, such as diesel or gas, to produce mechanical energy.

The mast 24 of the well rig 12 is movably mounted on the rig chassis 20 such that the mast 24 is movable between a transport position and an operating position. Typically, in the transport position, the mast 24 may be lowered such that a longitudinal axis Lm of the mast 24 is substantially horizontal to a longitudinal axis Lrc of the rig chassis 20. In the operating position, the mast 24 may be raised such that the longitudinal axis Lm of the mast 24 is substantially orthogonal to the longitudinal axis Lrc of the rig chassis 20.

The drawworks 26 is configured to raise equipment and lower equipment suspended from the mast 24 when the mast 24 is in the operating position.

Masts 24 and drawworks 26 for well rigs 12 are well known to people having ordinary skill in the art, and as such, will not be detailed herein. For example, U.S. patent application publication 2024/0200407 A1 discusses masts 24 and drawworks 26 of a workover rig for wells. Patent application publication US 2024/0200407 A1 is hereby incorporated by reference in its entirety herein.

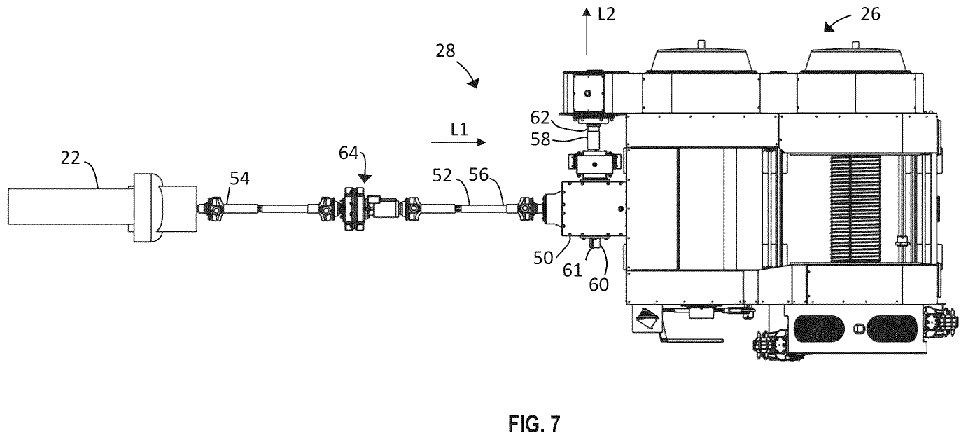

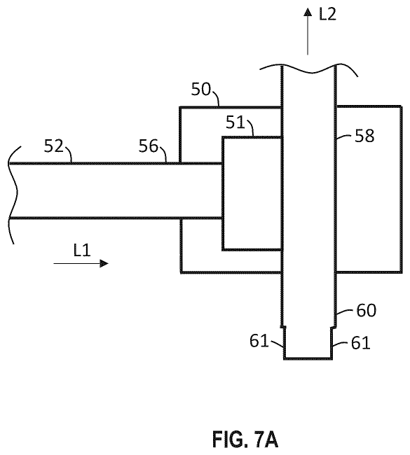

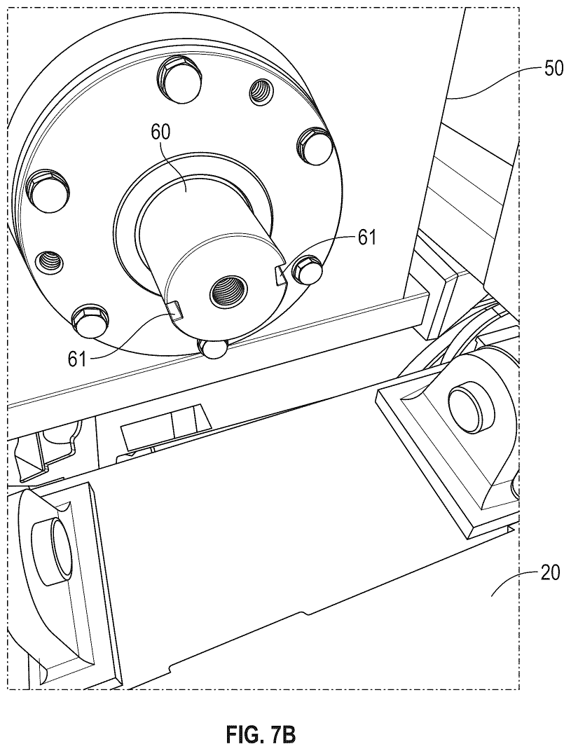

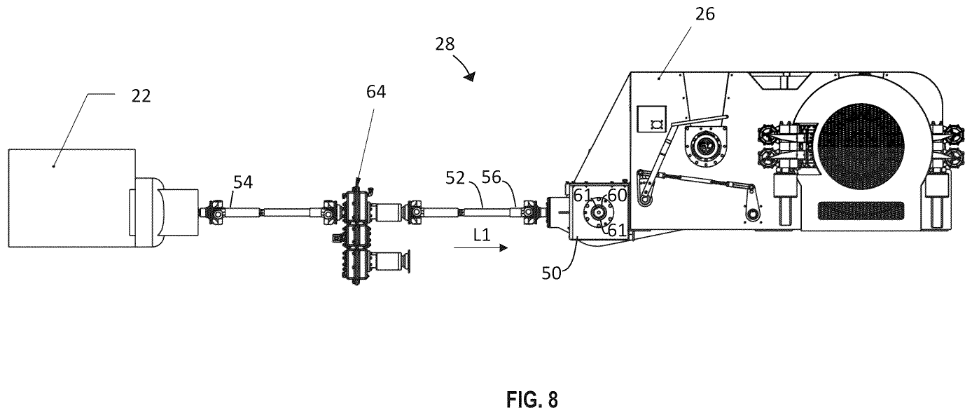

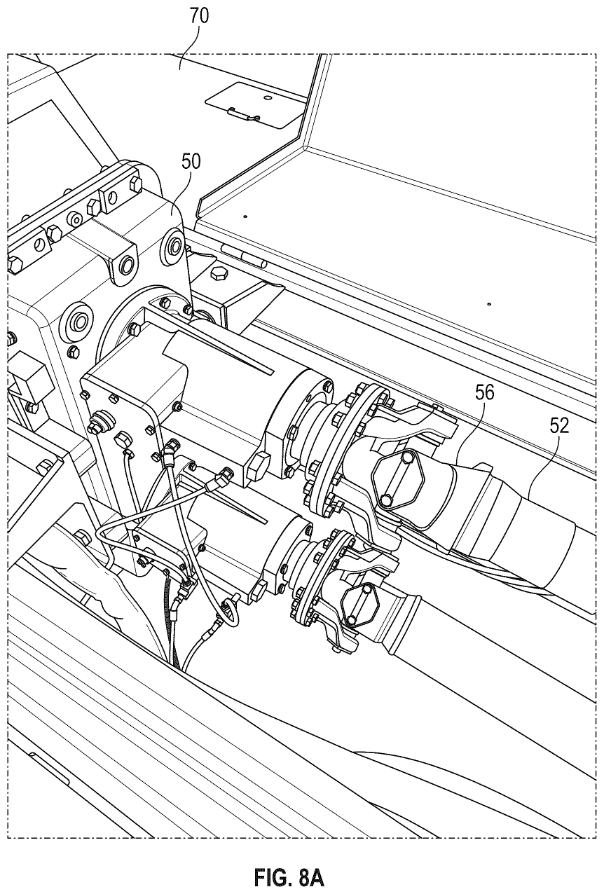

As shown in FIGS. 7, 7A, 7B, 8, and 8A, the rig drive system 28 may comprise a rig gear box 50 having one or more rig gears 51, a rig input shaft 52 having a proximal end 54 rotatably driven by the engine 22 and a distal end 56 rotatably engageable with the rig gear box 50, and a rig output shaft 58 having a proximal end 60 rotatably engaged with the rig gear box 50 and a distal end 62 mechanically rotatably engaged with the drawworks 26. In some embodiments, the rig drive system 28 may comprise a compound box 64 positioned between the engine 22 and the proximal end 54 of the rig input shaft 52

The rig input shaft 52 may be configured to transfer mechanical energy from the engine 22 to the rig gear box 50, such as to the one or more rig gears 51, when the rig input shaft 52 is engaged with the rig gear box 50.

The rig output shaft 58 is configured to transfer mechanical energy to the drawworks 26, such as to raise and lower the equipment suspended from the mast 24. In one embodiment, the rig output shaft 58 is configured to transfer mechanical energy to the drawworks 26 directly. When the rig input shaft 52 is engaged with the rig gear box 50, the rig gears 51 of the rig gear box 50 may be configured to transfer mechanical energy to the rig output shaft 58.

In one embodiment, as shown in FIGS. 7A and 7B, the proximal end 60 of the rig output shaft 58 may extend out of the rig gear box 50, orthogonally to the rig input shaft 52. In one embodiment, the proximal end 60 of the rig output shaft 58 may have one or more keyways 61. In one embodiment, the proximal end 60 of the rig output shaft 58 may have two keyways 61. In one embodiment, the rig output shaft 58 may be removed and replaced with another rig output shaft 58 having one or more of the keyways 61.

The rig gear box 50 may be a right-angle gear box, such that a longitudinal axis L1 of the rig output shaft 58 is orthogonal to a longitudinal axis L2 of the rig input shaft 52. When used in conjunction with the rig input shaft 52, the rig gear box 50 may have rig gears 51 having a gear ratio of 2.47 to 1. In some embodiments, when used in conjunction with the rig input shaft 52, the rig gears 51 the rig gear box 50 may have a gear ratio of 3.3 to 1 or of 2.5 to 1. The gear ratio may be designed based on input and desired output. For example, the gear ratio may be chosen based on the input of mechanical energy and the needed output of mechanical energy to supply energy to the drawworks 26 based on the size and/or weight of the mast 24 and/or equipment to be moved on the mast 24.

As shown in FIG. 8A, the rig input shaft 52 may be configured to be disengageable from the rig gears 51 in the rig gear box 50, such that movement of the rig input shaft 52 is not transferred to the rig gears 51. The rig output shaft 58 may be configured to continue to be engaged with the rig gears 51 whether or not the rig input shaft 52 is disengaged from the rig gears 51 or the rig output shaft 58 may be configured to be disengaged from the rig gears 51.

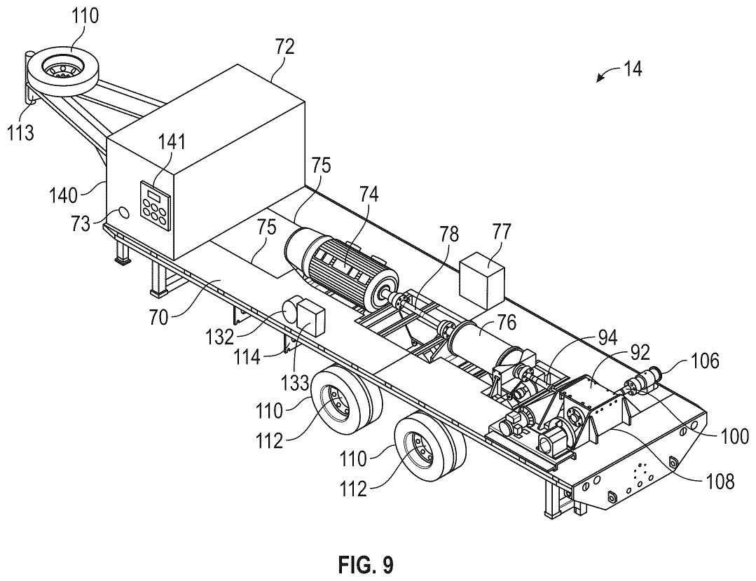

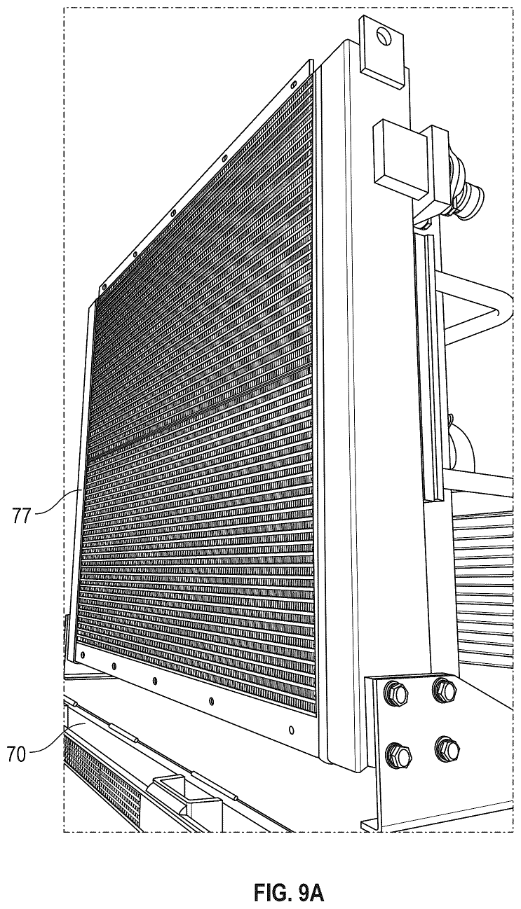

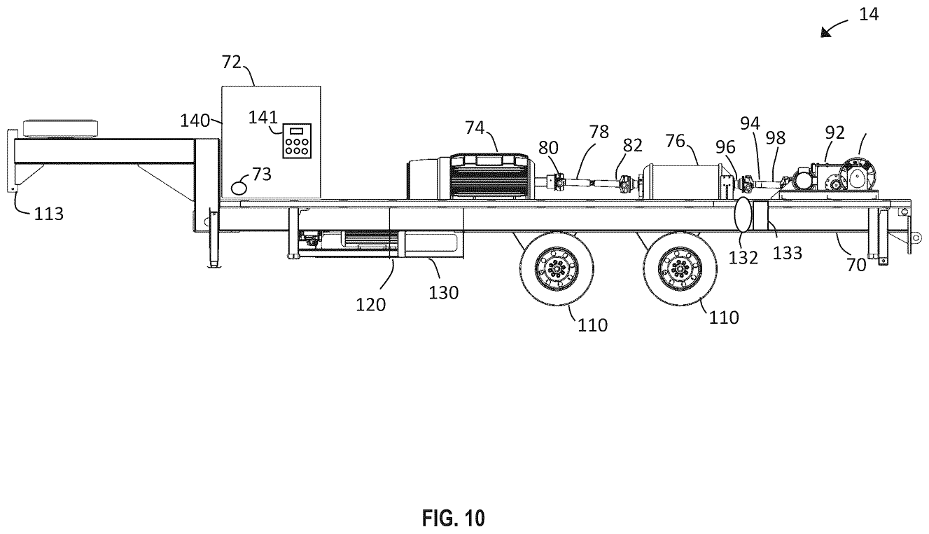

As shown in FIGS. 9, 10, and 11, the power generation system 14 (which may be referred to as the PGS 14 or the mobile power-generation system 14) may comprise a PGS chassis 70; a motor controller 72 (such as a variable-frequency drive 72) mounted on the PGS chassis 70 configured to receive electrical energy; and an electric motor 74 mounted on the PGS chassis 70, electrically connected to the variable-frequency drive 72, and configured to receive the electric energy from the variable-frequency drive 72 and convert the electrical energy into mechanical energy. The electric motor 74 may be electrically connected to the variable-frequency drive 72 via one or more wires 75. The power generation system 14 may further comprise a transmission 76 mounted on the PGS chassis 70 and a drive shaft 78 having a proximal end 80 rotatably engaged with the electric motor 74 and having a distal end 82 rotatably engaged with the transmission 76. The drive shaft 78 is configured to transfer the mechanical energy from the electric motor 74 to the transmission 76.

The transmission 76 may be a remote mount transmission configured to produce one or more levels of desired output torque, such as through the use of transmission gears, from the energy provided via the drive shaft 78 by the electric motor 74. In one embodiment, the transmission 76 may be a six-gear transmission. The desired output torque may be determined based on the torque needed to run the drawworks 26. The transmission 76 may be cooled with transmission fluid.

In some embodiments, such as shown in FIGS. 9 and 9A, the power generation system 14 may comprise a transmission cooling system 77 that is fluidly connected to the transmission 76 and that is configured to cool the transmission fluid. The transmission cooling system 77 may be powered electrically. The transmission cooling system 77 may be fluidly connected to the transmission 76 via one or more cooling fluid hoses.

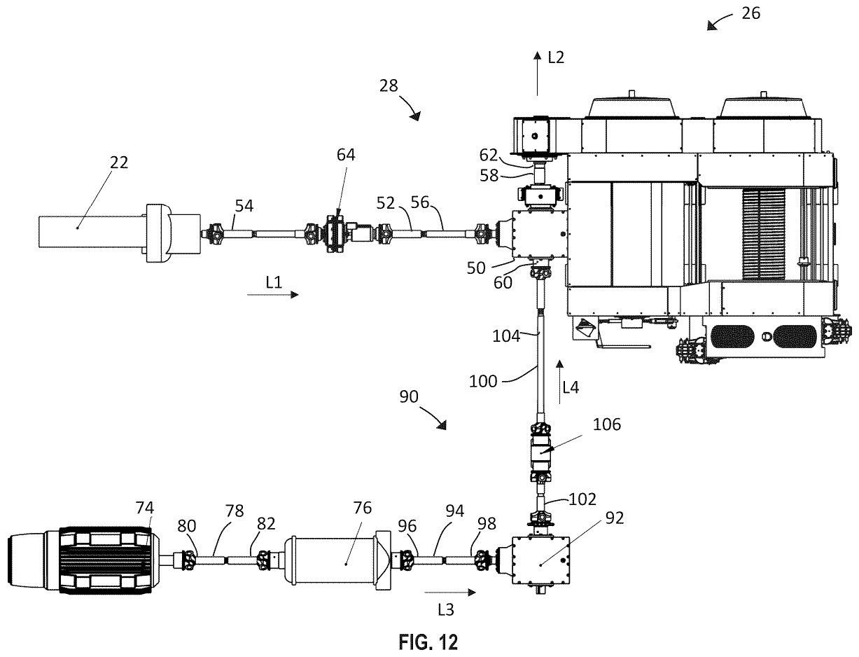

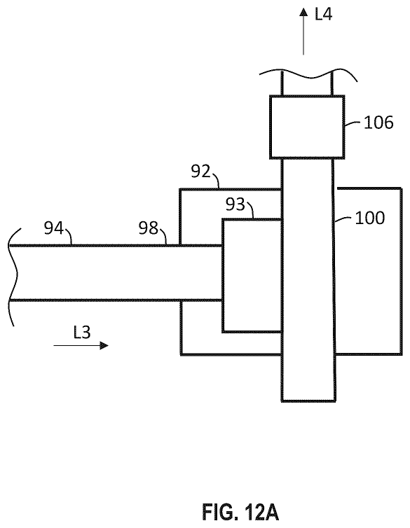

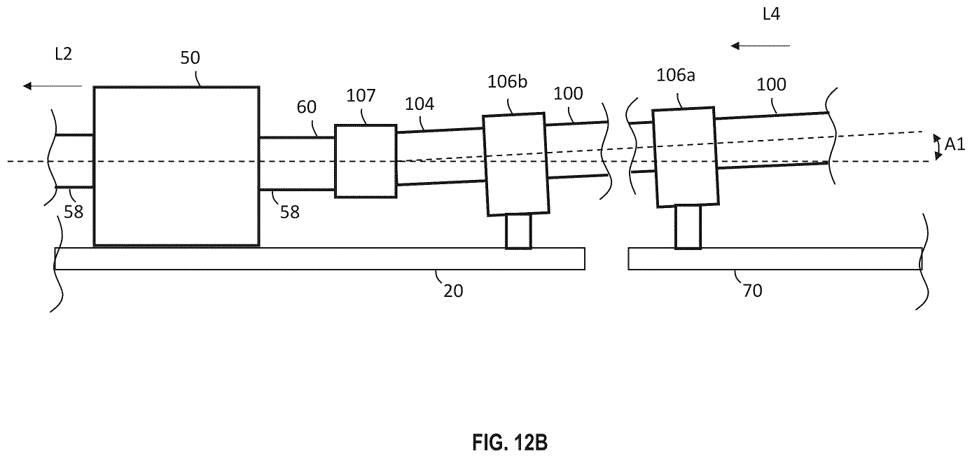

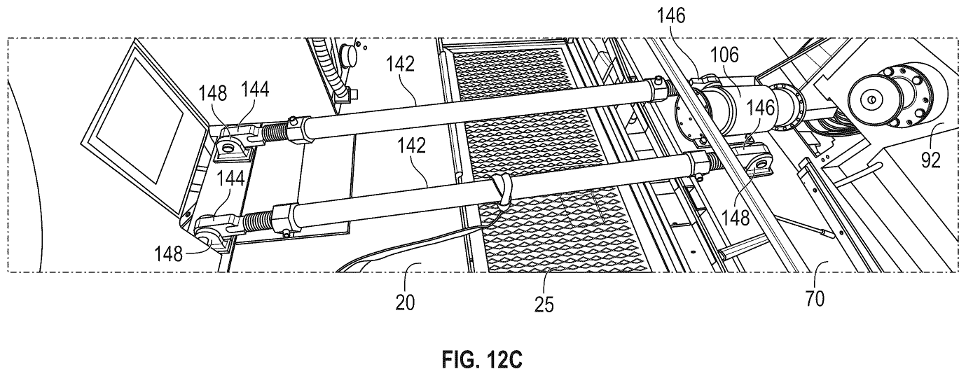

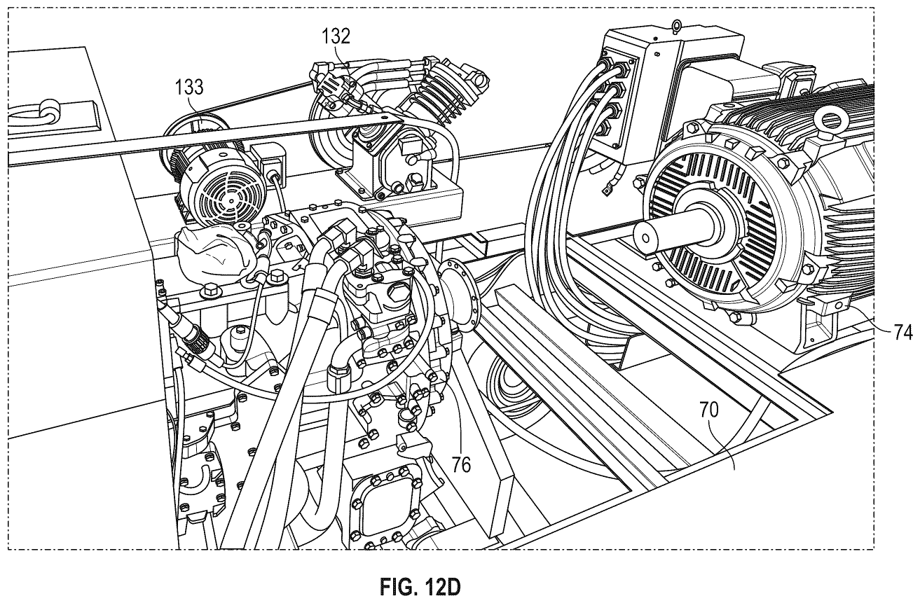

The power generation system 14 may also comprise a PGS drive system 90 mounted on the PGS chassis 70. As also shown in in FIG. 12, The PGS drive system 90 may comprise a PGS gear box 92 having one or more PGS gears 93; a PGS input shaft 94 having a proximal end 96 rotatably engaged with the transmission 76 and a distal end 98 rotatably engaged with the PGS gear box 92. The PGS input shaft 94 is configured to transfer the mechanical energy from the transmission 76 to the PGS gear box 92. The PGS input shaft 94 has a longitudinal axis L3.

The PGS drive system 90 of the power generation system 14 may also comprise a PGS output shaft 100 having a proximal end 102 rotatably engaged with the PGS gear box 92 and a distal end 104 extending beyond the PGS chassis 70 (FIGS. 1, 2, and 4). The PGS output shaft 100 has a longitudinal axis L4. The proximal end 102 of the PGS output shaft 100 may be engaged with the one or more PGS gears 93 of the PGS gear box in order to receive mechanical energy from the PGS input shaft 94 via the one or more PGS gears 93.

The distal end 104 of the PGS output shaft 100 is rotatably engageable with the rig output shaft 58 of the mobile well-rig 12, such that when the rig input shaft 52 is disengaged from the rig gear box 50 and the PGS output shaft 100 is engaged with the rig gear box 50, the PGS output shaft 100 is configured to transfer the mechanical energy through the rig gear box 50 and through the rig output shaft 58 to the drawworks 26 of the mobile well-rig 12.

The distal end 104 of the PGS output shaft 100 may be configured to engage with the rig output shaft 58. In one embodiment, PGS output shaft 100 may be configured to engage with the proximal end 60 of the rig output shaft 58 extending from the rig gear box 50. For example, the PGS output shaft 100 may be configured to engage with a shaft connector 107, such as a u-joint, flange or other connector, utilizing the one or more keyways 61 in the proximal end 60 of the rig output shaft 58. However, it will be understood that the PGS output shaft 100 may be configured to engage with the proximal end 60 of the rig output shaft 58 using other connection mechanisms.

As shown in FIG. 12B, when engaged with the rig output shaft 58, the PGS output shaft 100 may be positioned at an angle A1 of between three degrees and five and a half degrees vertically from the longitudinal axis L2 of the rig output shaft 58. In other words, the angle A1 may be an angle upwards from the PGS chassis 70 and the rig chassis 20.

As shown in the top plan view of FIG. 12A, the longitudinal axis L4 of the PGS output shaft 100 may be disposed at an angle to the longitudinal axis L3 of the PGS input shaft 94. In some embodiments, the PGS gear box 92 is a right-angle gear box, such that the longitudinal axis L4 of the PGS output shaft 100 is orthogonal to the longitudinal axis of the PGS input shaft 94. In some embodiments, the longitudinal axis L4 of the PGS output shaft 100 may be disposed at an angle to a longitudinal axis of the PGS chassis 70. In some embodiments, the longitudinal axis L4 of the PGS output shaft 100 may be orthogonal to the longitudinal axis of the PGS chassis 70.

The PGS drive system 90 may further comprise one or more carrier bearing assembly 106 positioned on and/or supporting the PGS output shaft 100. In some embodiments, the PGS drive system 90 may comprise two carrier bearing assemblies 106 configured to support the PGS output shaft 100. For example, in one embodiment, as shown in the front view of FIG. 12B, a first carrier bearing assembly 106a may be mounted to the PGS chassis 70 and a second carrier bearing assembly 106b may be mounted to the rig chassis 20. In some embodiments, the PGS drive system 90 may comprise one carrier bearing assembly 106. The quantity of the carrier bearing assemblies 106 used may be determined based on the longitudinal length and/or weight of the PGS output shaft 100, for example.

In some embodiments, the one or more PGS gears 93 of the PGS gear box 92 have a gear ratio of 2.47 to 1. In some embodiments, the one or more PGS gears 93 of the PGS gear box 92 may have a gear ratio of 3.3 to 1 or of 2.5 to 1. The gear ratio may be designed based on input and output. For example, the gear ratio may be chosen based on the input of mechanical energy and the needed output of mechanical energy to supply energy to the drawworks 26 based on the size and/or weight of the mast 24 and/or equipment to be moved on the mast 24.

In some embodiments, the PGS gear box 92 may be mounted to the PGS chassis 70 with, and/or supported by, a rear gear box mount 108 (FIG. 9).

Returning to FIGS. 9, 10, and 11, the PGS chassis 70 may be, or be part of, a trailer having a plurality of wheels 110 and one or more axle 112 supporting the PGS chassis 70. The trailer may have a hitch 113 for connecting to a tow vehicle. In some embodiments, the PGS chassis 70 may have supports 114 that may be utilized to move the power generation system 14, such as to move the power generation system 14 with a forklift.

In some embodiments, the PGS chassis 70 may have one or more adjustable supports 115 configured to move the PGS chassis 70 vertically, so as to align the PGS output shaft 100 vertically to a desired vertical angle (such as the angle A1) with the rig output shaft 58. In some embodiments, the adjustable supports 115 may be hydraulic jacks. In some embodiments, the PGS chassis 70 may have four adjustable supports 115.

The variable-frequency drive 72 may be connected to an electrical power interface 73 configured to receive electrical energy from any external electrical energy source. The electrical energy source may be a regional electric grid, such as supplied by an electric company. The electrical energy source may be one or more of: solar panels, wind generators, batteries, mixed-fuel generators, natural-gas-based generators, hydrogen generators. The variable-frequency drive 72 may output the electrical energy. In some embodiments, the variable-frequency drive may be an electronics conversion system comprising a rectifier bridge converter; a direct current (DC) link; and an inverter, for example.

The variable-frequency drive 72 may be utilized to control the electric motor 74 in precise increments. In one embodiment, the variable-frequency drive 72 may be configured to adjust the frequency of an incoming alternating current, while maintaining an output voltage from the variable-frequency drive 72 at a steady level of direct current, so as to adjust the electric motor 74 to run at one or more desired levels of revolutions per minute.

In some embodiments, power generation system 14 may comprise a hydraulic pump 120 mounted on the PGS chassis 70, and configured to connect to hydraulic components on the mobile well-rig 12 to provided pressurized fluid to the hydraulic components of the mobile well-rig 12. The hydraulic pump 120 may also provide pressurized fluid to other hydraulic components, such as on the power generation system 14. For example, in some embodiments, when the adjustable supports 115 are hydraulic jacks, the hydraulic jacks may be powered by the hydraulic pump 120. The hydraulic pump 120 may be connected to the hydraulic components of the mobile well-rig 12 and/or the power generation system 14 via one or more hydraulic hoses.

In some embodiments, the power generation system 14 may comprise a second electric motor 130 supported by the PGS chassis 70. The second electric motor 130 may be electrically connected to receive electrical energy from an external source. In some embodiments, the second electric motor 130 may provide mechanical energy to one or more other components of the mobile power generation system 14. For example, the second electric motor 130 may be mechanically connected to the hydraulic pump 120 to provide mechanical energy to the hydraulic pump 120.

In some embodiments, the electric motor 74 may have a first power rating and the second electric motor 130 may have a second power rating different than the first power rating.

In some embodiments, the first power rating for the electric motor 74 is in a range between 200 horsepower and 1000 horsepower. In some embodiments, the first power rating for the electric motor 74 is 600 horsepower. In some embodiments, the second power rating for the second electric motor 130 is in a range between 40 horsepower and 80 horsepower. In some embodiments, the second power rating for the second electric motor 130 is 60 horsepower.

Determining a particular configuration of the electric motor 74 and a desired power rating for the electric motor 74 may be based on the desired output to the transmission 76 in order for the transmission 76 to provide the torque needed to power the drawworks 26. For example, a larger electric motor 74 with a higher first power rating may be utilized in the PGS system 14 when the drawworks 26 needs more torque to move the mast 24 and/or equipment of the rig 12. A smaller electric motor 74 with a lower first power rating may be utilized in the PGS system 14 when the drawworks 26 needs less torque to move the mast 24 and/or equipment of the rig 12, such as when the mast 24 and/or equipment are lighter and/or smaller.

The electric motor 74 may be configured to provide output at full power at startup of the electric motor 74.

As shown in FIG. 12D, in some embodiments, the power generation system 14 may comprise an air compressor 132 mounted on the PGS chassis 70. The air compressor 132 may be configured to connect to pneumatic components on the mobile well-rig 12 and/or the power generation system 14 to provide pressurized air to the pneumatic components on the mobile well-rig 12 and/or the power generation system 14. The air compressor 132 may be connected to the pneumatic components with one or more air hoses. In some embodiments, the power generation system 14 may comprise a third electric motor 133 that may power the air compressor 132. The third electric motor 133 may be electrically connected to receive electrical energy from an external source.

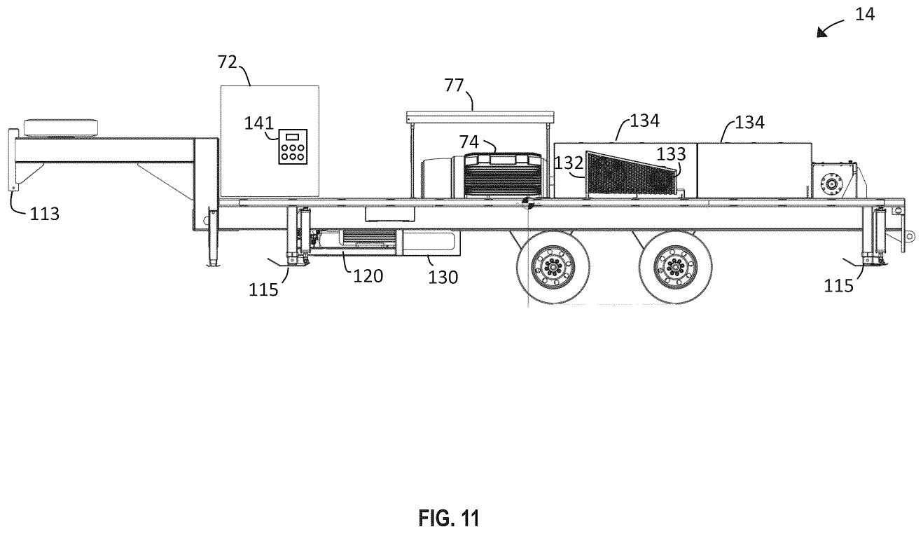

In some embodiments, one or more components of the power generation system 14 may be enclosed in one or more covers 134 or housings, such as shown in FIG. 11.

In some embodiments, the power generation system 14 may comprise an electrical cabinet 140, which may cover all or part of the variable-frequency drive 72 and which may include electrical components to route the electrical connections from the external electrical source to one or more of: the variable-frequency drive 72, the second electric motor 130, the third electric motor 133, the transmission cooling system 77, and/or other electrical components. The electrical power interface 73 may also be part of and/or routed through the electrical cabinet 140.

In some embodiments, the electrical cabinet 140 may have one or more PGS controller user interfaces 141 configured to control operation of the power generation system 14. The one or more PGS controller user interfaces 141 may be positioned on or near the power generation system 14, such as on, near, or in the electrical cabinet 140, and/or may be positioned remotely from the PGS chassis 70. For example, in one embodiment, one or more of the PGS controller user interface(s) 141 may be positioned with, or as part of, the controller 29 positioned on the mobile well-rig 12.

In some embodiments, as shown in FIG. 12C, the mobile well-rig alternate power system 10 may comprise one or more chassis-connectors 142 to rigidly connect the well-rig 12 and the power generation system 14. The one or more chassis-connectors 142 when in use may rigidly connect the well-rig 12 and the power generation system 14 such that movement of the well-rig 12 is translated to the power generation system 14, such that the PGS output shaft 100 is able to maintain a stable connection with the rig output shaft 58 when the well-rig 12 moves.

For example, the one or more chassis-connectors 142 may rigidly connect the rig chassis 20 and the PGS chassis 70. Each of the chassis-connectors 142 may have a first end 144 and a second end 146 and a rigid chassis-connector length extending between the first end 144 and the second end 146. The first end 144 may be connected to the rig chassis 20 and the second end 146 may be connected to the PGS chassis 70. In some embodiments, the first end 144 and/or the second end 146 may be connected to the rig chassis 20 and the PGS chassis 70, respectively, with one or more brackets 148 (such as one or more pads) that are previously connected to the rig chassis 20 and the PGS chassis 70. In some embodiments, the first end 144 and/or the second end 146 of the one or more chassis-connectors 142 may be connected to the brackets 148 with one or more pins.

In some embodiments, one or more of the chassis-connectors 142 may be positioned parallel to the PGS output shaft 100 when connected to the rig chassis 20 and the PGS chassis 70. In some embodiments, one or more of the chassis-connectors 142 when connected to the rig chassis 20 and the PGS chassis 70 may be positioned at an acute angle in relation to the PGS output shaft 100. For example, one or more of the chassis-connectors 142 may be positioned diagonally across the rig chassis 20 and the PGS chassis 70.

In some embodiments, the chassis-connector length may be adjustable in a longitudinal direction. For example, the one or more chassis-connectors 142 may be one or more turnbuckles.

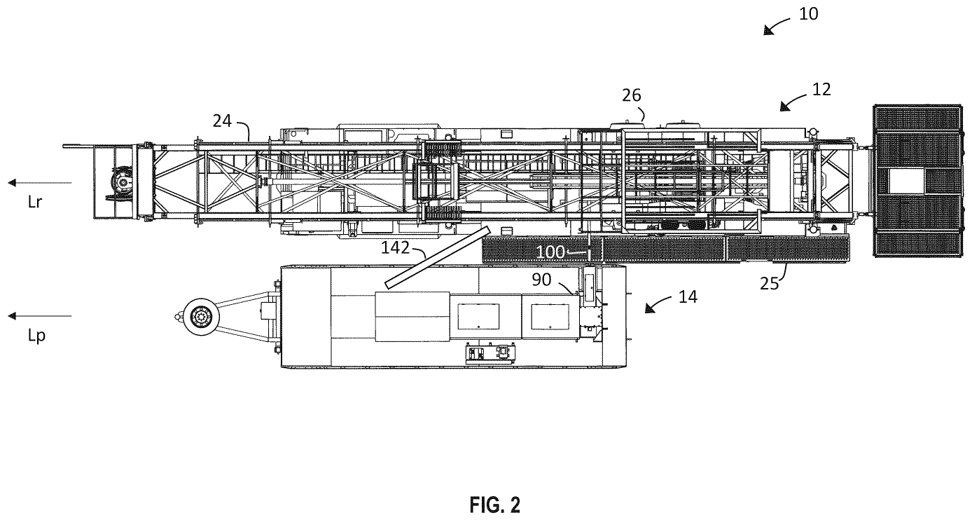

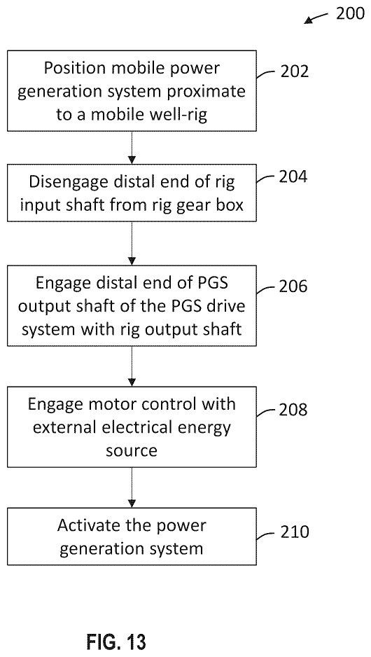

One exemplary use of the mobile well-rig alternate power system 10 will now be described. As illustrated in FIG. 13, a method 200 of use of the mobile power generation system 14 for providing alternate power to the mobile well-rig 12 may comprise a step 202 of positioning the power generation system 14 proximate to the mobile well-rig 12. In some embodiments, the well-rig 12 has a rig longitudinal axis Lr and the power generation system 14 has a PGS longitudinal axis Lp and the power generation system 14 is positioned such that the PGS longitudinal axis Lp is substantially parallel to the rig longitudinal axis Lr (FIG. 2). In such an embodiment, substantially parallel may mean that the PGS longitudinal axis Lp is at an angle of between zero degrees and ten degrees to the rig longitudinal axis Lr. In some embodiments, the power generation system 14 may be positioned at a distance of between zero inches and twelve inches from the well-rig 12. The power generation system 14 may be positioned at a distance of approximately three inches from the well-rig 12.

When the PGS chassis 70 is a trailer or part of a trailer, the power generation system 14 may be moved into position by a tow vehicle, such as a truck, moving the trailer proximate to the mobile well-rig 12 at the well site.

In some embodiments, the power generation system 14 may be moved into position proximate to the mobile well-rig 12 by a forklift or other lifting equipment.

In a step 204 of the method 200, a user may disengage and/or disconnect the distal end 56 of the rig input shaft 52 from the rig gear box 50 of the mobile well-rig 12, such that the rig input shaft 52 no longer turns the rig gears 51 in the rig gear box 50 and/or such that the rig gears 51 in the rig gear box 50 do not turn the rig input shaft 52 when the rig input shaft 52 rotates.

In some embodiments, the user may rigidly connect the rig chassis 20 to the PGS chassis 70 using one or more of the chassis-connectors 142. The user may connect the first end 144 of the chassis-connector 142 to the rig chassis 20, such as by using one of the brackets 148 that is on the rig chassis 20, and may connect the second end 146 to the PGS chassis 70, such as by using one of the brackets 148 that is on the PGS chassis 70. The one or more of the chassis-connectors 142 may be positioned parallel to the PGS output shaft 100 and the rig output shaft 58, for example. One or more of the chassis-connectors 142 may be positioned diagonally to the PGS output shaft 100 and the rig output shaft 58.

In a step 206, the user may engage the distal end 104 of the PGS output shaft 100 of the PGS drive system 90 with the rig output shaft 58 of the mobile well-rig 12, such that the PGS output shaft 100 is able to provide rotational power to the rig output shaft 58.

In some embodiments, the user may vertically position the PGS drive system 90 such as by raising or lowering the PGS chassis 70. For example, the user may vertically position the PGS chassis 70 by raising or lowering one or more of the adjustable supports 115. The user may vertically position the PGS chassis such that the PGS output shaft 100 forms the angle A1 of between three degrees and five and a half degrees vertically from the longitudinal axis L2 of the rig output shaft 58.

In some embodiments, the user may utilize the one or more keyways 161 and the shaft connector 107 to connect the PGS output shaft 100 of the PGS drive system 90 with the rig output shaft 58 of the mobile well-rig 12. In some embodiments, the user may remove the rig output shaft 58 and replace the rig output shaft 58 with a second rig output shaft 58 having the one or more keyways 161, and then connect the PGS output shaft 100 of the PGS drive system 90 with the rig output shaft 58 of the mobile well-rig 12 utilizing the shaft connector 107 and the one or more keyways 161 on the second rig output shaft 58.

In a step 208, the user may engage the variable-frequency drive 72 of the mobile power generation system 14 with the external electrical energy source, such as through the electrical power interface 73. The user may also engage the second electric motor 130 and/or the third electric motor 133 with the external electrical energy source, such as through the electrical power interface 73 through the electrical cabinet 140.

In a step 210, the user may activate the electric motor 74 of the power generation system 14, thereby providing mechanical energy through the transmission 76 and the PGS drive system 90 to the rig output shaft 58 and thereby to the drawworks 26 of the mobile well-rig 12. In some embodiments, the electric motor may automatically activate when the user engages the variable-frequency drive 72 with the external electrical energy source. In some embodiments, the user may utilize one or more of the PGS controller user interface(s) 141 to control the power generation system 14 and, thereby, control the drawworks 26.

The user may activate the second electric motor 130 such as to power and/or control the hydraulic pump 120 in order to provide hydraulic pressure. The user may activate the third electric motor 133 such as to power and/or control the air compressor 132 to provide pneumatic pressure.

In some embodiments, the user may activate the electric motor 74, the second electric motor 130, and/or the third electric motor 133 through a single switch and/or multiple switches and/or through the one or more PGS controller user interfaces 141.

The user may then operate the drawworks 26 to raise equipment or lower equipment via the mast 24, using the mechanical energy powered by the electric motor 74 using electrical energy from the external electrical energy source. The user may utilize one or more of the PGS controller user interface(s) 141 and/or the controller 29 (which may be separate and/or integrated together) to control the power generation system 14 and control the drawworks 26 and to control the mobile well-rig alternate power system 10 and components thereof.

The user may utilize one or more of the PGS controller user interface(s) 141 and/or the controller 29 to control the pneumatic components and/or hydraulic components.

As the mobile well-rig alternate power system 10 is in use, the well-rig 12 may experience movement, which may be translated to the power generation system 14 via the rigid connection(s) formed by the one or more chassis-connectors 142, which may serve to maintain the transfer of rotational mechanical power from the PGS output shaft 100 to the rig output shaft 58 and to the drawworks 26.

As will be understood by a person having ordinary skill in the art, the method 200 described above is one example of how the mobile well-rig alternate power system 10 may be utilized, but the mobile well-rig alternate power system 10 may be utilized in other manners and for other purposes.

Exemplary clauses describing embodiments of the inventions and methods include the following:
Clause 1. An external power generation system for a mobile well rig, comprising:
a power-generation-system (PGS) chassis;
a motor controller mounted on the PGS chassis, the motor controller having an electrical power interface configured to receive electrical energy from an external electric energy source and output the electrical energy;
an electric motor mounted on the PGS chassis and configured to receive the electrical energy from the motor controller and convert the electrical energy into mechanical energy;
a transmission mounted on the PGS chassis;
a drive shaft having a proximal end rotatably engaged with the electric motor and having a distal end rotatably engaged with the transmission, the drive shaft configured to transfer the mechanical energy from the electric motor to the transmission; and
a drive system mounted on the PGS chassis, the drive system comprising:
a first gear box having one or more PGS gears;
an input shaft having a proximal end rotatably engaged with the transmission and a distal end rotatably connected to the first gear box, the input shaft configured to transfer the mechanical energy from the transmission to the first gear box; and
an output shaft having a proximal end rotatably engaged with the first gear box and a distal end extending beyond the chassis and configured to be rotatably connected to a rig output shaft of a mobile well-rig, thereby transferring the mechanical energy to the rig output shaft, the rig output shaft configured to transfer the mechanical energy to a drawworks of the mobile well-rig to raise and lower equipment suspended from a mast of the mobile well-rig.
Clause 2. The external power generation system of Clause 1, wherein the motor controller is a variable-frequency drive.
Clause 3. The external power generation system of Clause 1 or 2, wherein the first gear box is a right-angle gear box, such that a longitudinal axis of the output shaft is orthogonal to a longitudinal axis of the input shaft.
Clause 4. The external power generation system of Clause 1 or 2, wherein a longitudinal axis of the output shaft is disposed at an angle to a longitudinal axis of the PGS chassis.
Clause 5. The external power generation system of any one of Clauses 1-4, wherein the PGS chassis is part of a trailer having a plurality of wheels supporting the PGS chassis.
Clause 6. The external power generation system of any one of Clauses 1-5, wherein the mobile well-rig is a mobile workover rig for servicing a well.
Clause 7. The external power generation system of any one of Clauses 1-5, wherein the mobile well-rig is a mobile drilling rig for drilling a well.
Clause 8. The external power generation system of any one of Clauses 3-7, wherein the motor controller is a variable-frequency drive, and wherein the variable-frequency drive is an electronics conversion system comprising:
a rectifier bridge converter;
a direct current (DC) link; and
an inverter.
Clause 9. The external power generation system of any one of Clauses 1-8, comprising a hydraulic pump, mounted on the PGS chassis, and configured to connect to hydraulic components on the mobile well-rig to provide pressurized fluid to the hydraulic components.
Clause 10. The external power generation system of any one of Clauses 1-9, comprising an air compressor mounted on the PGS chassis, and configured to connect to pneumatic components on the mobile well rig to provide pressurized air to the pneumatic components.
Clause 11. The external power generation system of any one of Clauses 1-10, comprising a carrier bearing assembly supporting the output shaft of the drive system.
Clause 12. The external power generation system of any one of Clauses 1-11, wherein the electric motor is a first electric motor having a first power rating, the external power generation system comprising a second motor supported by the PGS chassis, the second motor having a second power rating different than the first power rating, wherein the second motor provides mechanical energy to a hydraulic pump.
Clause 13. The external power generation system of Clause 12, wherein the first power rating is in a range between 500 horsepower and 700 horsepower, and the second power rating is in a range between 40 horsepower and 80 horsepower.
Clause 14. The external power generation system of any one of Clauses 1-13, wherein the first gear box has a set of gears with a gear ratio of 2.47 to 1.
Clause 15. A mobile well-rig alternate power system, comprising:
a mobile well-rig, comprising:
a rig chassis;
an engine supported by the rig chassis, the engine configured to run on petroleum products to produce mechanical energy;
a mast movably mounted on the rig chassis such that the mast is movable between a transport position and an operating position;
a drawworks mounted on the rig chassis and configured to raise and lower equipment suspended from the mast when the mast is in the operating position; and
a rig drive system mounted on the rig chassis, the rig drive system comprising:
a rig gear box having one or more rig gears;
a rig input shaft having a proximal end driven by the engine and a distal end rotatably engageable with the one or more rig gears in the rig gear box, the rig input shaft configured to transfer mechanical energy from the engine to the rig gear box when the rig input shaft is engaged with the rig gear box; and
a rig output shaft having a proximal end and a distal end, the distal end mechanically rotatably engaged with the drawworks, the rig output shaft configured to transfer mechanical energy to the drawworks to raise and lower the equipment suspended from the mast, the rig output shaft having a first state in which the rig output shaft receives mechanical energy via the rig gears from the rig input shaft and having a second state in which the rig output shaft receives no mechanical energy from the rig input shaft when the rig input shaft is disengaged from the rig gears of the rig gear box; and
a mobile power generation system (PGS), positioned external to the mobile well-rig, comprising:
a PGS chassis;
a motor controller mounted on the PGS chassis, the motor controller having an electrical power interface configured to receive electrical energy from an external electrical energy source and output the electrical energy;
an electric motor mounted on the PGS chassis and configured to receive the electric energy from the motor controller and convert the electrical energy into mechanical energy;
a transmission mounted on the PGS chassis;
a drive shaft having a proximal end rotatably engaged with the electric motor and having a distal end rotatably engaged with the transmission, the drive shaft configured to transfer the mechanical energy from the electric motor to the transmission; and
a PGS drive system mounted on the PGS chassis, the PGS drive system comprising:
a PGS gear box having one or more PGS gears;
a PGS input shaft having a proximal end rotatably engaged with the transmission and a distal end rotatably engaged with the PGS gears of the PGS gear box, the PGS input shaft configured to transfer the mechanical energy from the transmission to the PGS gears of the PGS gear box; and
a PGS output shaft having a proximal end rotatably engaged with the PGS gears of the PGS gear box and a distal end extending beyond the PGS chassis and rotatably engageable with the rig output shaft of the mobile well-rig when the rig output shaft is in the second state, such that when the rig input shaft is disengaged from the rig gears of the rig gear box and the PGS output shaft is engaged with the rig gear box, the PGS output shaft is configured to transfer the mechanical energy through the rig output shaft to the drawworks of the mobile well-rig.
Clause 16. The mobile well-rig alternate power system of Clause 15, wherein the rig chassis of the mobile well-rig is part of a vehicle comprising a plurality of rig wheels supporting the rig chassis and comprising a cab having controls for driving the vehicle.
Clause 17. The mobile well-rig alternate power system of Clause 15, wherein the PGS gear box is a right-angle gear box, such that a longitudinal axis of the PGS output shaft is orthogonal to a longitudinal axis of the PGS input shaft.
Clause 18. The mobile well-rig alternate power system of Clause 15, wherein a longitudinal axis of the PGS output shaft is disposed at an angle to a longitudinal axis of the PGS chassis.
Clause 19. The mobile well-rig alternate power system of Clause 15, wherein the PGS chassis is part of a trailer having a plurality of wheels supporting the PGS chassis.
Clause 20. The mobile well-rig alternate power system of Clause 15, wherein the mobile well-rig is a mobile workover rig for servicing a well.
Clause 21. The mobile well-rig alternate power system of Clause 15, wherein the mobile well-rig is a mobile drilling rig for drilling a well.
Clause 22. The mobile well-rig alternate power system of Clause 15, wherein the motor controller is a variable-frequency drive, and wherein the variable-frequency drive is an electronics conversion system comprising:
a rectifier bridge converter;
a direct current (DC) link; and
an inverter.
Clause 23. The mobile well-rig alternate power system of Clause 15, wherein the mobile power generation system comprises a hydraulic pump mounted on the PGS chassis and configured to connect to hydraulic components on the mobile well-rig to provided pressurized fluid to the hydraulic components.
Clause 24. The mobile well-rig alternate power system of Clause 15, wherein the mobile power generation system comprises an air compressor mounted on the PGS chassis and configured to connect to pneumatic components on the mobile well-rig to provide pressurized air to the pneumatic components.
Clause 25. The mobile well-rig alternate power system of Clause 15, wherein the mobile power generation system comprises a carrier bearing assembly positioned on the PGS output shaft of the PGS drive system.
Clause 26. The mobile well-rig alternate power system of Clause 15, wherein the electric motor is a first electric motor having a first power rating, the mobile power generation system comprising a second electric motor supported by the PGS chassis, the second electric motor having a second power rating different than the first power rating, the second electric motor configured to provide mechanical energy to a hydraulic pump.
Clause 27. The mobile well-rig alternate power system of Clause 26, wherein the first power rating is in a range between 200 horsepower and 1000 horsepower, and the second power rating is in a range between 40 horsepower and 80 horsepower.
Clause 28. The mobile well-rig alternate power system of Clause 15, wherein the PGS gear box has a set of PGS gears with a gear ratio of 2.47 to 1.
Clause 29. The mobile well-rig alternate power system of Clause 15, wherein the motor controller is a variable-frequency drive.
Clause 30. A method for providing alternate power to a mobile well-rig, comprising:
positioning a mobile power generation system (PGS) proximate to a mobile well-rig, the mobile well-rig comprising:
a rig chassis;
an engine supported by the rig chassis, the engine configured to run on petroleum products to produce mechanical energy;
a mast movably mounted on the rig chassis such that the mast is movable between a transport position and an operating position;
a drawworks mounted on the rig chassis and configured to raise and lower equipment suspended from the mast when the mast is in the operating position; and
a rig drive system mounted on the rig chassis, the rig drive system comprising:
a rig gear box having one or more rig gears;
a rig input shaft having a proximal end driven by the engine and a distal end rotatably engageable with the rig gear box, the rig input shaft configured to transfer mechanical energy from the engine to the rig gear box when the rig input shaft is engaged with the rig gear box; and
a rig output shaft having a proximal end and a distal end, the distal end mechanically rotatably engaged with the drawworks, the rig output shaft configured to transfer mechanical energy to the drawworks to raise and lower the equipment suspended from the mast, the rig output shaft having a first state in which the rig output shaft receives mechanical energy via the rig gears from the rig input shaft and having a second state in which the rig output shaft receives no mechanical energy from the rig input shaft when the rig input shaft is disengaged from the rig gears of the rig gear box; and
wherein the mobile power generation system (PGS) comprises:
   a PGS chassis;
a motor controller mounted on the PGS chassis, the motor controller having an electrical power interface configured to receive electrical energy from an external electrical energy source and output the electrical energy;
an electric motor mounted on the PGS chassis and configured to receive the electric energy from the motor controller and convert the electrical energy into mechanical energy;
a transmission mounted on the PGS chassis;
a drive shaft having a proximal end rotatably engaged with the electric motor and having a distal end rotatably engaged with the transmission, the drive shaft configured to transfer the mechanical energy from the electric motor to the transmission; and
a PGS drive system mounted on the PGS chassis, the PGS drive system comprising:
a PGS gear box having one or more PGS gears;
a PGS input shaft having a proximal end rotatably engaged with the transmission and a distal end rotatably engaged with the PGS gear box, the PGS input shaft configured to transfer the mechanical energy from the transmission to the PGS gear box; and
a PGS output shaft having a proximal end rotatably engaged with the PGS gear box and a distal end extending beyond the PGS chassis and rotatably engageable with the rig gear box of the mobile well-rig;
disengaging the distal end of the rig input shaft from the rig gears of the rig gear box;
engaging the PGS output shaft of the PGS drive system with the rig output shaft; and
activating the electric motor of the mobile power generation system, thereby providing mechanical energy through the transmission and the PGS drive system to the drawworks of the mobile well-rig.
Clause 31. The method for providing alternate power to a mobile well-rig of Clause 30, wherein the motor controller is a variable-frequency drive.
Clause 32. The method for providing alternate power to a mobile well-rig of Clause 30, comprising: engaging the motor controller of the mobile power generation system with the external electrical energy source via the electrical power interface.
Clause 33. The method for providing alternate power to a mobile well-rig of Clause 30, comprising:
attaching a first end of one or more chassis-connectors to the rig chassis; and
attaching a second end of the one or more chassis-connectors to the PGS chassis, such that the rig chassis and the PGS chassis are rigidly connected.
Clause 34. The method for providing alternate power to a mobile well-rig of Clause 30, wherein positioning the mobile power generation system proximate to the mobile well-rig comprises positioning the mobile power generation system longitudinally to the mobile well-rig at a distance of less than twelve inches.
Clause 35. The method for providing alternate power to a mobile well-rig of Clause 30, wherein positioning the mobile power generation system proximate to the mobile well-rig comprises positioning the mobile power generation system longitudinally to the mobile well-rig at a distance of between two and four inches.
Clause 36. The method for providing alternate power to a mobile well-rig of Clause 30, wherein the mobile power generation system comprises one or more adjustable supports connected to the PGS chassis, the method comprising: adjusting the adjustable supports to vertically position the PGS drive system such that the PGS output shaft forms an angle of between three degrees and five and a half degrees vertically from a longitudinal axis of the rig output shaft.
Clause 37. The method for providing alternate power to a mobile well-rig of Clause 30, wherein the electric motor has a power rating of between 100 horsepower and 1000 horsepower.
Clause 38. The method for providing alternate power to a mobile well-rig of Clause 30, wherein the electric motor has a power rating of 600 horsepower.
Clause 39. The method for providing alternate power to a mobile well-rig of Clause 30, wherein the PGS gears have a gear ratio of 2.47 to 1.
Clause 40. The method for providing alternate power to a mobile well-rig of Clause 30, wherein the rig output shaft is a first rig output shaft, the method comprising: replacing the first rig output shaft with a second rig output shaft, the second rig output shaft having one or more keyways in the proximal end, and wherein engaging the PGS output shaft of the PGS drive system with the rig output shaft comprises engaging the PGS output shaft of the PGS drive system with the second rig output shaft using a shaft connector that engages with the one or more keyways of the second rig output shaft.

### CONCLUSION

Conventionally, many rigs for drilling or servicing wells use diesel engines for operating rig drawworks. However, diesel engines produce greenhouse gas emissions and high noise levels. Replacing or extensively retrofitting such rigs to replace the diesel engines and connected systems to reduce or eliminate the greenhouse gas emissions and noise levels is expensive and time consuming. In accordance with the present disclosure, an electrical-based, power generation system includes an electric motor that drives the rig gear box via a drive system of a mobile power generation system, which reduces or eliminates emissions and reduces noise levels.

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment.

What is claimed is:

1. An external power generation system for a mobile well rig, comprising:
a power-generation-system (PGS) chassis;
a motor controller mounted on the PGS chassis, the motor controller having an electrical power interface configured to receive electrical energy from an external electric energy source and output the electrical energy;
an electric motor mounted on the PGS chassis and configured to receive the electrical energy from the motor controller and convert the electrical energy into mechanical energy;
a transmission mounted on the PGS chassis;
a drive shaft having a proximal end rotatably engaged with the electric motor and having a distal end rotatably engaged with the transmission, the drive shaft configured to transfer the mechanical energy from the electric motor to the transmission; and
a drive system mounted on the PGS chassis, the drive system comprising:
a first gear box having one or more PGS gears;
an input shaft having a proximal end rotatably engaged with the transmission and a distal end rotatably connected to the first gear box, the input shaft configured to transfer the mechanical energy from the transmission to the first gear box; and
an output shaft having a proximal end rotatably engaged with the first gear box and a distal end extending beyond the chassis and configured to be rotatably connected to a rig output shaft of a mobile well-rig, thereby transferring the mechanical energy to the rig output shaft, the rig output shaft configured to transfer the mechanical energy to a drawworks of the mobile well-rig to raise and lower equipment suspended from a mast of the mobile well-rig.

2. The external power generation system of claim 1, wherein the motor controller is a variable-frequency drive.

3. The external power generation system of claim 1, wherein the first gear box is a right-angle gear box, such that a longitudinal axis of the output shaft is orthogonal to a longitudinal axis of the input shaft.

4. The external power generation system of claim 1, wherein a longitudinal axis of the output shaft is disposed at an angle to a longitudinal axis of the PGS chassis.

5. The external power generation system of claim 1, wherein the PGS chassis is part of a trailer having a plurality of wheels supporting the PGS chassis.

6. The external power generation system of claim 1, wherein the mobile well-rig is a mobile workover rig for servicing a well.

7. The external power generation system of claim 1, wherein the mobile well-rig is a mobile drilling rig for drilling a well.

8. The external power generation system of claim 1, wherein the motor controller is a variable-frequency drive, and wherein the variable-frequency drive is an electronics conversion system comprising:
a rectifier bridge converter;
a direct current (DC) link; and
an inverter.

9. The external power generation system of claim 1, comprising a hydraulic pump, mounted on the PGS chassis, and configured to connect to hydraulic components on the mobile well-rig to provide pressurized fluid to the hydraulic components.

10. The external power generation system of claim 1, comprising an air compressor mounted on the PGS chassis, and configured to connect to pneumatic components on the mobile well rig to provide pressurized air to the pneumatic components.

11. The external power generation system of claim 1, comprising a carrier bearing assembly supporting the output shaft of the drive system.

12. The external power generation system of claim 1, wherein the electric motor is a first electric motor having a first power rating, the external power generation system comprising a second motor supported by the PGS chassis, the second motor having a second power rating different than the first power rating, wherein the second motor provides mechanical energy to a hydraulic pump.

13. The external power generation system of claim 12, wherein the first power rating is in a range between 500 horsepower and 700 horsepower, and the second power rating is in a range between 40 horsepower and 80 horsepower.

14. The external power generation system of claim 1, wherein the first gear box has a set of gears with a gear ratio of 2.47 to 1.

15. A method for providing alternate power to a mobile well-rig, comprising:
positioning a mobile power generation system (PGS) proximate to a mobile well-rig, wherein the mobile power generation system (PGS) comprises:
a PGS chassis;
a motor controller mounted on the PGS chassis, the motor controller having an electrical power interface configured to receive electrical energy from an external electrical energy source and output the electrical energy;
an electric motor mounted on the PGS chassis and configured to receive the electric energy from the motor controller and convert the electrical energy into mechanical energy;
a transmission mounted on the PGS chassis;
a drive shaft having a proximal end rotatably engaged with the electric motor and having a distal end rotatably engaged with the transmission, the drive shaft configured to transfer the mechanical energy from the electric motor to the transmission; and
a PGS drive system mounted on the PGS chassis, the PGS drive system comprising:
a PGS gear box having one or more PGS gears;
a PGS input shaft having a proximal end rotatably engaged with the transmission and a distal end rotatably engaged with the PGS gear box, the PGS input shaft configured to transfer the mechanical energy from the transmission to the PGS gear box; and
a PGS output shaft having a proximal end rotatably engaged with the PGS gear box and a distal end extending beyond the PGS chassis;
engaging the PGS output shaft of the PGS drive system with a rig output shaft having a proximal end and a distal end, the distal end mechanically rotatably engaged with a drawworks of the mobile well-rig, the rig output shaft configured to transfer mechanical energy to the drawworks; and
activating the electric motor of the mobile power generation system, thereby providing mechanical energy through the transmission and the PGS drive system to the drawworks of the mobile well-rig.

16. The method of claim 15, wherein the mobile well-rig comprises:
a rig chassis;
an engine supported by the rig chassis, the engine configured to run on petroleum products to produce mechanical energy;
a mast movably mounted on the rig chassis such that the mast is movable between a transport position and an operating position;
wherein the drawworks is mounted on the rig chassis and configured to raise and lower equipment suspended from the mast when the mast is in the operating position; and
a rig drive system mounted on the rig chassis, the rig drive system comprising:
a rig gear box having one or more rig gears;
a rig input shaft having a proximal end driven by the engine and a distal end rotatably engageable with the rig gear box, the rig input shaft configured to transfer mechanical energy from the engine to the rig gear box when the rig input shaft is engaged with the rig gear box; and
the rig output shaft wherein the rig output shaft configured to transfer mechanical energy to the drawworks to raise and lower equipment suspended from the mast, the rig output shaft having a first state in which the rig output shaft receives mechanical energy via the rig gears from the rig input shaft and having a second state in which the rig output shaft receives no mechanical energy from the rig input shaft when the rig input shaft is disengaged from the rig gears of the rig gear box; and
the method comprising:
disengaging the distal end of the rig input shaft from the rig gears of the rig gear box before activating the electric motor of the mobile power generation system.

17. The method for providing alternate power to a mobile well-rig of claim
15, comprising:
attaching a first end of one or more chassis-connectors to a rig chassis of the mobile well-rig; and
attaching a second end of the one or more chassis-connectors to the PGS chassis, such that the rig chassis and the PGS chassis are rigidly connected.

18. The method for providing alternate power to a mobile well-rig of claim 15, wherein the mobile power generation system comprises one or more adjustable supports connected to the PGS chassis, the method comprising:
adjusting the adjustable supports to vertically position the PGS drive system such that the PGS output shaft forms an angle of between three degrees and five and a half degrees vertically from a longitudinal axis of the rig output shaft.

19. The method for providing alternate power to a mobile well-rig of claim 15, wherein the PGS gears have a gear ratio of 2.47 to 1.

20. The method for providing alternate power to a mobile well-rig of claim 15, wherein the rig output shaft is a first rig output shaft, the method comprising:
replacing the first rig output shaft with a second rig output shaft, the second rig output shaft having one or more keyways in the proximal end, and wherein engaging the PGS output shaft of the PGS drive system with the rig output shaft comprises engaging the PGS output shaft of the PGS drive system with the second rig output shaft using a shaft connector that engages with the one or more keyways of the second rig output shaft.
